(19) United States
(12) Patent Application Publication
(10) Pub. No.: US 2005/0190819 A1
(43) Pub. Date: Sep. 1, 2005

(54) Apparatus and method for providing code timing acquisition in a mobile communication system using multiple antennas

(75) Inventors: Yun-Ju Kwon, Suwon-si (KR); Chul-Jin Kim, Yongin-si (KR); June-Hyeok Im, Seoul (KR); In-Kwon Paik, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/065,269

(22) Filed: Feb. 25, 2005

(30) Foreign Application Priority Data
Feb. 26, 2004 (KR) 2004-13138

(51) Int. Cl. H04B 1/713

(52) U.S. Cl. 375/148; 375/152

(57) ABSTRACT

A reception apparatus and method are provided for acquiring code timing by receiving pilot signals spread with allocated codes in a receiver using multiple antennas, wherein a transmitter using multiple antennas allocates different codes to pilot signals for transmitting through the respective antennas. The apparatus and method comprise receiving the spread pilot signals through the respective antennas; outputting estimated propagation delay values of the pilot signals transmitted from the respective antennas of the transmitter and peak values of matched filters for respective channels; and calculating new estimated propagation delay values by applying weights determined based on the peak values of matched filters for respective channels to the estimated propagation delay values, and acquiring code timing with the new estimated propagation delay values.

### PRIORITY

This application claims the benefit under 35 U.S.C. § 119(a) to an application entitled “Apparatus and Method for Offering Code Timing Acquisition in a Mobile Communication System Using Multiple Antennas” filed in the Korean Intellectual Property Office on Feb. 26, 2004 and assigned Serial No. 2004-13138, the entire contents of which are incorporated herein by reference.

### BACKGROUND OF THE INVENTION

1. Field of the Invention

The present invention relates generally to an apparatus and method for providing code timing acquisition in a mobile communication system. In particular, the present invention relates to an apparatus and method for providing code timing acquisition in a mobile communication system using multiple antennas.

2. Description of the Related Art

The next generation mobile communication system requires a higher data rate and a higher system capacity, compared with the current mobile communication system. Recently, in order to meet the requirements, active research is being conducted on technologies for transmitting/receiving data using multiple antennas. In order to understand the multiantenna technique, it is necessary to first understand the wireless and cellular environments. One of the reasons that the wireless channel is difficult to transmit data on compared to the wired channel is due to fading in which channels vary in strength with the passage of time. As a typical example of schemes for effectively overcoming fading, there is a diversity scheme for forming channels whose fading varies independently and receiving signals using the channels, thereby establishing a stable path. The diversity can be classified into frequency diversity, time diversity, and space diversity. Among them, space diversity can use multiple antennas.

There are various multiantenna techniques according to the systems and channel environments, to which they are applied. There are several advantages that can be realized using multiple antennas, and one of them is the space diversity described above. Space diversity offers lower fluctuations of fading, and serves to secure channels similar to the channels having only white noises without fading. In order to acquire such a space diversity effect, correlation between antennas should be reduced.

As an alternative multiantenna technique, there is a smart antenna technique. In a smart antenna system, when simultaneously receiving signals from a plurality of mobile stations, a base station assigns appropriate weights to their associated antennas according to positions of the mobile stations, thereby efficiently acquiring the signals received from the mobile stations. That is, the smart antenna system can achieve a higher system capacity, compared to a multiuser detection (MUD) system that simultaneously detects data from a plurality of users using a single antenna. However, simultaneously detecting data from a plurality of users is much greater in complexity than independently detecting data received from the users via a single antenna.

In addition, because the smart antenna technique includes a technique of receiving signals using a plurality of antennas and a technique of transmitting signals using a plurality of antennas, both a transmitter and a receiver have multiple antennas and adjust weights uniquely assigned to the antennas, thereby achieving greater performance. A technique in which both a base station and a mobile station use smart antennas is called Smart antennas at the Base and Mobile stations (SBM). In SBM, both the base station and the mobile station remove interferences, showing outstanding interference cancellation capabilities.

If SBM transmits a plurality of data streams in parallel for one mobile station instead of transmitting a single data stream, it can achieve a higher data rate. An open-loop Multiple Input Multiple Output (MIMO) technique, also known as Bell-lab Layered Space Time (BLAST) architecture, refers to a technique of selecting a smaller one out of M and N, and transmitting the selected number of data streams in a system having M transmission antennas and N reception antennas. The MIMO technique receives signals using the technique used in the MUD system.

A mobile communication system using the MIMO technique is illustrated in FIG. 1. As illustrated in FIG. 1, after a multiplexing section 10 space-multiplexes transmission data, a spreading section 20 spreads pilot signals with codes uniquely allocated to respective transmission antennas, for correct channel estimation. The spread data passes through independent Rayleigh fading channels 30 based on rich scattering characteristics, formed between multiple transmission antennas and a single reception antenna. Here, if a transmission side has N antennas and a reception side has N antennas, an N×N channel matrix H exists between the N antennas of the receiver and the N antennas of the transmitter.

In the receiver, when pilot data simultaneously transmitted by all transmission antennas is received, the received pilot data is input to an Accurate Differential Correlated-Matched Filter (ADC-MF) 40. The ADC-MF 40, a detailed structure of which is illustrated in FIG. 2, performs the following operation.

A sampler 41 performs sampling on the signal received from the transmitter via its associated antenna, generates a complex vector signal, and outputs the complex vector signal to a matched filter 42. The matched filter 42 performs matched-filtering on the complex vector signal output from the sampler 41, and outputs the filtered signal to a complex conjugator and a delay 43. The complex conjugator calculates a cross correlation between the signal output from the matched filter 42 and a symbol-delayed signal output from the delay 43. A calculator 44 receives the cross correlation and outputs a cross correlation sequence in the form of a matrix. Although a conceptual data flow is shown above, because the cross correlation and matched filtering processes are simultaneously performed in implementation, the results thereof are induced to a quadratic equation of a fractional delay desired to be estimated. Therefore, a propagation delay is acquired by calculating a solution of the quadratic equation. The quadratic equation can be expressed as Equation (1).

$${δ}_{1} = {δ}_{1} ( d ) = \frac{g ( 0 ) ∓ P ( d ) g ( 1 )}{( g ( 0 ) - g ( 1 ) ) ( 1 \pm P ( d ) )} \qquad ( 1 )$$

where

$$g ( i ) {=}^{def} {{η}_{1 m} ( d )}^{T} {η}_{1 m} ( d + i ) , \qquad P ( d ) = \sqrt{\frac{\vert {{η}_{1 m} ( d )}^{T} {R}_{p} ( χ ) {η}_{1 m} ( d ) \vert}{\vert {{η}_{1 m} ( d + 1 )}^{T} {R}_{p} ( χ ) {η}_{1 m} ( d + 1 ) \vert}} ,$$

η₁ₘ(d) denotes a cyclic shift of a sample sequence of an m^{th} antenna of a desired user, and Rₚ(χ) denotes a cross correlation matrix of a received signal.

FIG. 3 illustrates a timing diagram of asynchronous-sampled signals received at a receiver. In FIG. 3, bₖ denotes transmission data, sₖ denotes a spreading code, and rₖ denotes a reception signal. In addition, ‘d’ denotes an integer-based difference between a timing of transmission data and a sampling timing of a reception signal, and δ denotes a fractional delay within one chip. Further, cₖₗ denotes an asynchronous difference in the left direction on the basis of a negative edge of transmission data, and \overline{c}ₖₗ denotes an asynchronous difference in the right direction on the basis of the negative edge of transmission data. If reception data modeled with the timing shown in FIG. 3 passes through the ADC-MF 40, the result is defined as a function of code alignment between a data timing of the transmitter and a sampling timing of the receiver, and an equal gain of channel coefficients formed between multiple transmission antennas and a single reception antenna. Generally, a Weighted Average technique is more efficient than an Equal Gain Average technique in terms of performance. In addition, the number of allocated codes should increase to the number of transmission antennas in order to perform channel estimation for each transmission antenna, causing a code scarcity problem.

### SUMMARY OF THE INVENTION

It is, therefore, an object of the present invention to provide a Time Division Pilot data Transmission and Selective Weighted Average (TDPT-SWA) method by applying a Multiple Input Multiple Output (MIMO) technique to a mobile communication system.

It is another object of the present invention to provide a Non Time Division Pilot data Transmission and Selective Weighted Average (NTDPT-SWA) method by applying a MIMO technique to a mobile communication system.

In accordance with one aspect of the present invention, there is provided a reception method for acquiring code timing by receiving pilot signals spread with allocated codes in a receiver using multiple antennas, wherein a transmitter using multiple antennas allocates different codes to pilot signals for transmitting through the respective antennas. The method comprises the steps of receiving the spread pilot signals through the respective antennas; outputting estimated propagation delay values of the pilot signals transmitted from the respective antennas of the transmitter and peak values of matched filters for respective channels; and calculating new estimated propagation delay values by applying weights determined based on the peak values of matched filters for respective channels to the estimated propagation delay values, and acquiring code timing with the new estimated propagation delay values.

In accordance with another aspect of the present invention, there is provided a reception method for acquiring code timing by receiving pilot signals spread with allocated codes for different times in a receiver using multiple antennas, wherein a transmitter using multiple antennas allocates the same code to pilot signals for transmitting through the respective antennas. The method comprises the steps of receiving the spread pilot signals through the respective antennas; outputting estimated propagation delay values of pilot signals transmitted from the respective antennas of the transmitter and peak values of matched filters for respective channels by separating pilot data output from the respective antennas of the transmitter for different times; and calculating new estimated propagation delay values by applying weights determined based on the peak values of matched filters for respective channels to the estimated propagation delay values, and acquiring code timing with the new estimated propagation delay values.

In accordance with further another aspect of the present invention, there is provided a reception apparatus for acquiring code timing by receiving pilot signals spared with allocated codes, wherein a transmitter using multiple antennas allocates different codes to pilot signals for transmitting through the respective antennas. The apparatus comprises an accurate differential correlated-matched filter (ADC-MF) for receiving spread pilot signals transmitted from the transmitter through the respective antennas, and outputting estimated propagation delay values of the pilot signals transmitted through the respective antennas of the transmitter and peak values of matched filters; and a weight application section for calculating new estimated propagation delay values by applying weights determined based on the peak values of matched filters for respective channels to the estimated propagation delay values, and acquiring code timing with the new estimated propagation delay values.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional code timing acquisition apparatus in a mobile communication system;

FIG. 2 is a detailed diagram of a conventional Accurate Differential Correlated-Matched Filter (ADC-MF) illustrated in FIG. 1;

FIG. 3 is a timing diagram of asynchronous-sampled signals received at a conventional receiver;

FIG. 4 is a block diagram of a code timing acquisition apparatus in a mobile communication system using multiple antennas according to an embodiment of the present invention;

FIG. 5 is a diagram provided for a description of a Selective Weighted Average (SWA) method in the weight application section of FIG. 4;

FIG. 6 is a diagram illustrating a pilot channel transmission data structure according to an embodiment of the present invention;

FIG. 7 is a flowchart illustrating a code timing acquisition method according to an embodiment of the present invention; and

FIGS. 8 to 11 are graphs illustrating a performance comparison between the proposed code timing acquisition methods and the conventional code timing acquisition method.

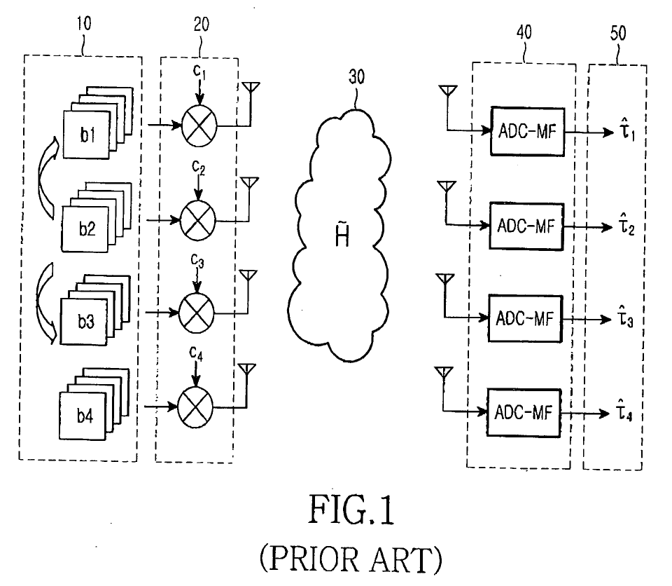

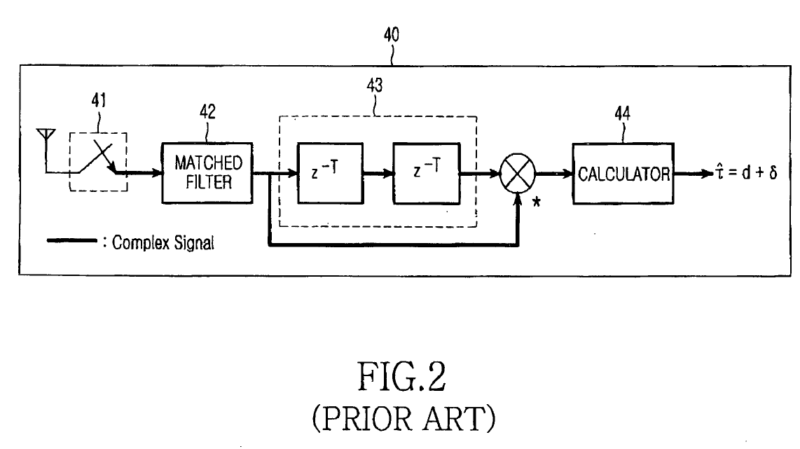

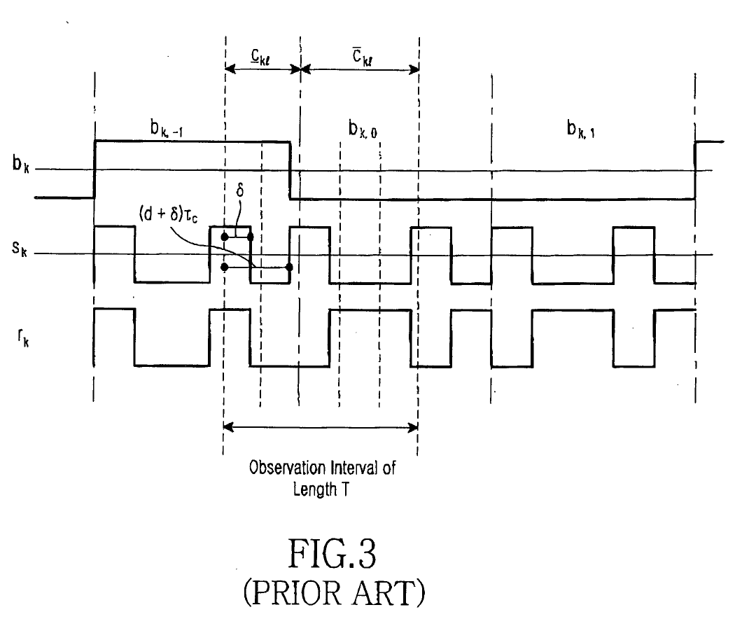

### DETAILED DESCRIPTION OF THE PREFERRED EMBODIMENT

An embodiment of the present invention will now be described in detail with reference to the accompanying drawings. In the following description, a detailed description of known functions and configurations incorporated herein has been omitted for conciseness.

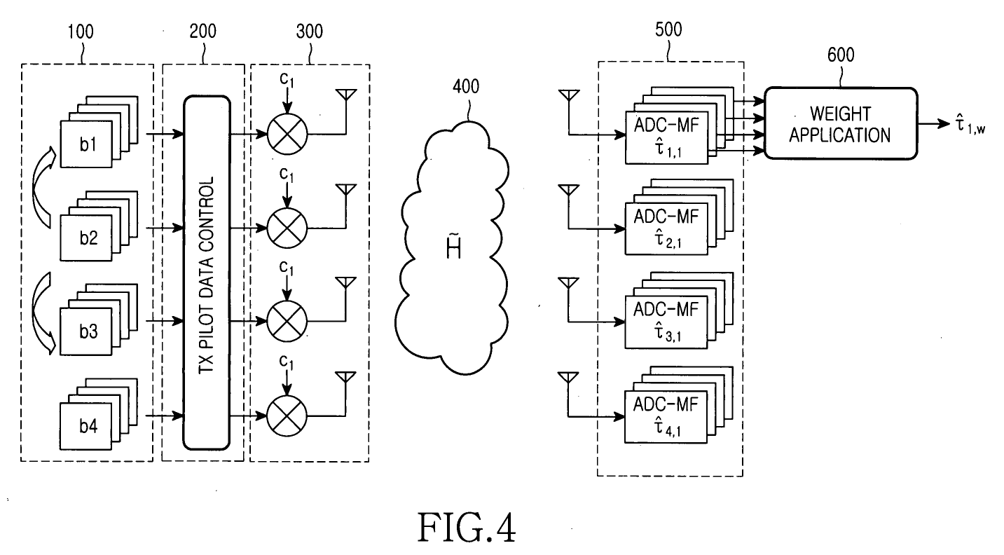

As illustrated in FIG. 4, a code timing acquisition apparatus in a mobile communication system according to an embodiment of the present invention is roughly divided into a transmission side (100, 200 and 300) and a reception side (500 and 600).

The embodiment of the present invention provides a Time Division Pilot data Transmission (TDPT) method in order to solve the problem that the number of orthogonal codes required to be allocated to pilot channels should be equal to the number of transmission antennas. It is assumed herein that a spreading section 300 allocates only one orthogonal code to all transmission antennas, and transmits pilot data only at one antenna using a pilot transmission period determined by dividing a channel coherence time by the number of the antennas. In this way, it is possible to transmit transmission data only at one antenna for different times using the same code.

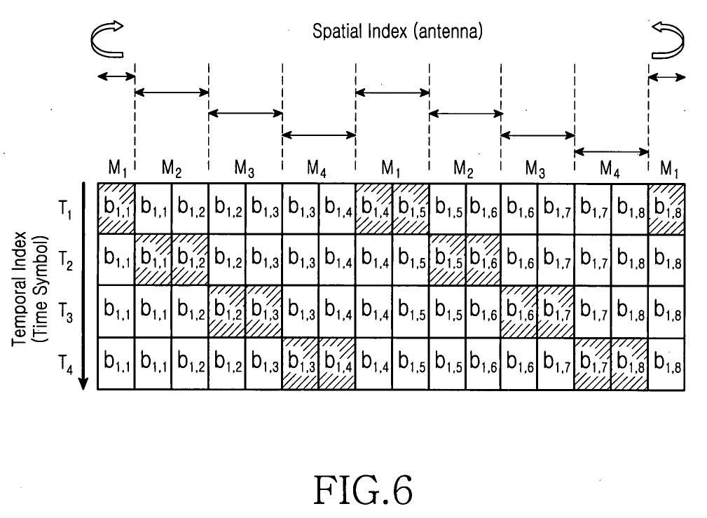

FIG. 4 illustrates a mobile communication system using multiple antennas according to an embodiment of the present invention. As illustrated in FIG. 4, a multiplexing section 100 space-multiplexes transmission pilot data, and outputs the multiplexed pilot data to a transmission pilot data control section 200. The transmission pilot data control section 200 performs a control operation such that the transmission pilot data should be transmitted only at one antenna for different times using the same code. A spreading section 300 spreads pilot signals with codes uniquely allocated to respective transmission antennas, for accurate channel estimation. An operation of the transmission pilot data control section 200 for Time Division Pilot data Transmission (TDPT) will be described later with reference to FIG. 6.

In the reception side (500 and 600), when pilot data simultaneously transmitted by all transmission antennas is received, the received pilot data is input to an Accurate Differential Correlated-Matched Filter (ADC-MF) 500. The ADC-MF 500 performs sampling on the signal received from the transmission side (100, 200 and 300), generates complex vector signals, and outputs the complex vector signals to an appropriate matched filter. The ADC-MF 500 calculates a cross correlation between a complex conjugate value of the output signal of the matched filter and a signal obtained by delaying the output signal of the matched filter for a predetermined time. Although a conceptual data flow is shown above, the cross correlation and matched filtering processes are simultaneously performed in implementation. Therefore, an estimated propagation delay value is induced to a quadratic equation of a fractional delay desired to be estimated. That is, an estimated propagation delay value is acquired by simply calculating a solution of the quadratic equation. The quadratic equation can be expressed as Equation (2).

$${δ}_{1} = {δ}_{1} ( d ) = \frac{g ( 0 ) ∓ P ( d ) g ( 1 )}{( g ( 0 ) - g ( 1 ) ) ( 1 \pm P ( d ) )} \qquad ( 2 )$$

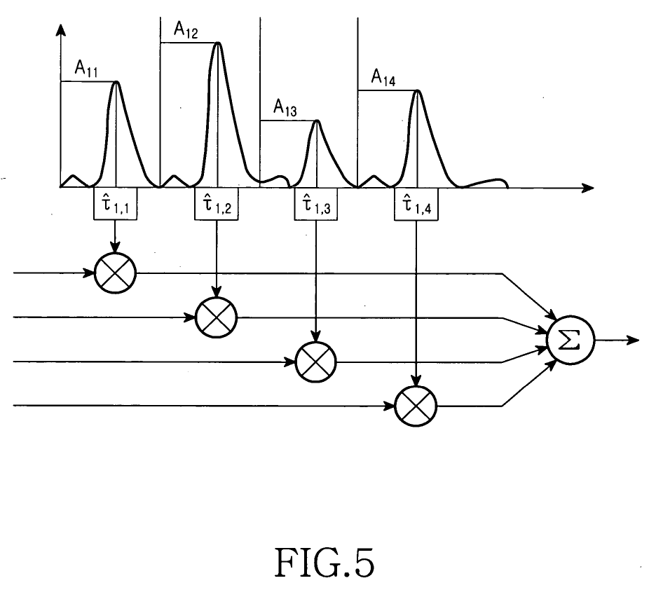

An estimated propagation delay value is output from the ADC-MF 500 in the manner described above. The estimated propagation delay value output from the ADC-MF 500 is the sum, τ=d+δ, of an integer delay value ‘d’ and a fractional delay value δ. The estimated propagation delay value is transmitted to a weight application section 600. As illustrated in FIG. 5, the weight application section 600 compares peak values A_{1,1}, A_{1,2}, A_{1,3}, A_{1,4} of matched filters, obtained when calculating estimated propagation delay values \hat{τ}_{1,1}, \hat{τ}_{1,2}, \hat{τ}_{1,3}, \hat{τ}_{1,4} for separated channels, and calculates relative weights on the basis of the maximum peak value. The weight application section 600 calculates new estimated propagation delay values by multiplying the previously calculated estimated propagation delay values by the relative weights. In this manner, the weight application section 600 can calculate the estimated propagation delay values using Selective Weighted Average (SWA) method.

FIG. 6 illustrates a pilot channel transmission data structure for transmitting pilot transmission data only at one antenna under the control of the transmission pilot data control section 200 in the transmission side in which the number of transmission antennas is 4, a diversity order is 2 and a pilot data transmission period is 1. That is, FIG. 6 is a diagram provided for a description of a Time Division Pilot data Transmission (TDPT) method in the transmission side. In FIG. 6, a horizontal axis represents an antenna number and a vertical axis represents a transmission symbol time. At a time T1, the transmission pilot data control section 200 outputs b_{1,1}, b_{1,4}, b_{1,5}, b_{1,8} through an antenna M1, and allocates ‘0’ to the remaining data to block outputting of the corresponding data. At a time T2, the transmission pilot data control section 200 outputs b_{1,1}, b_{1,2}, b_{1,5}, b_{1,6} through an antenna M2, and allocates ‘0’ to the remaining data to block outputting of the corresponding data. Also, at times T3 and T4, the transmission pilot data control section 200 outputs only the pilot data in the shaded parts, and allocates ‘0’ to the remaining data. That is, at a time T3, the transmission pilot data control section 200 outputs b_{1,2}, b_{1,3}, b_{1,6}, b_{1,7} through an antenna M3, and allocates ‘0’ to the remaining data to block outputting of the corresponding data. At a time T4, the transmission pilot data control section 200 outputs b_{1,3}, b_{1,4}, b_{1,7}, b_{1,8} through an antenna M4, and allocates ‘0’ to the remaining data to block outputting of the corresponding data. For the next symbol time, the transmission pilot data control section 200 repeats the foregoing process. By repeating the foregoing process, it is possible to transmit transmission data only at one antenna for different times using the same code.

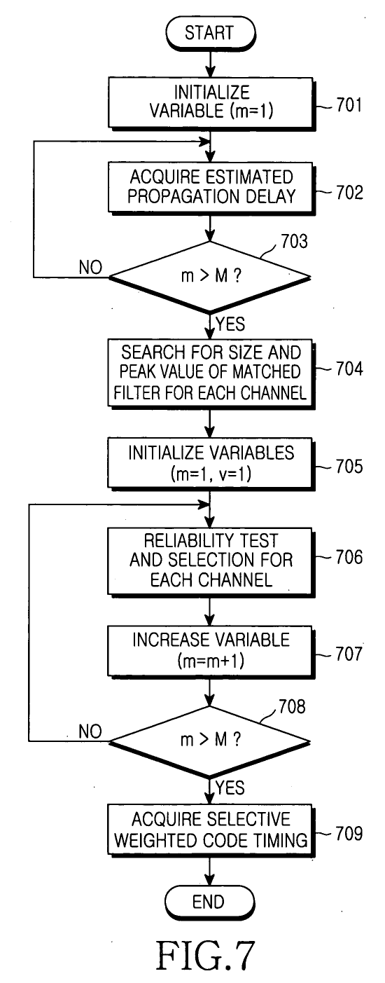

FIG. 7 is a flowchart illustrating a selective weighted code timing acquisition method in a mobile communication system according to an embodiment of the present invention. That is, FIG. 7 is a flowchart providing a description of a process of processing pilot signals received from a transmission side.

In step 701, the ADC-MF 500 receives pilot signals from the spreading section 300, and initializes a variable ‘m’ (m=1). In step 702, the ADC-MF 500 acquires estimated propagation delay values through a quadratic equation (see Equation (2)) for a fractional delay value. The estimated propagation delay values are output in the form of a sum of an integer delay value ‘d’ and a fractional delay value 8. In step 703, the ADC-MF 500 compares the variable ‘m’ with the number M of transmission antennas. If the variable ‘m’ is not larger than the number M of the transmission antennas, the ADC-MF 500 returns to step 702. However, if the variable ‘m’ is larger than the number M of the transmission antennas, the weight application section 600 searches for sizes and peak values of matched filters for respective channels, in step 704. That is, the weight application section 600 acquires accurate peak values using the acquired estimated propagation delay values, and then searches for an index of a channel having the maximum value among the peak values. The maximum value can be acquired using Equation (3).

$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert ) \qquad ( 3 )$$

where τₘ=dₘ+δₘ.

In step 705, the ADC-MF 500 initializes variables ‘m’ and ‘v’ (m=1, v=1). In step 706, the weight application section 600 performs reliability testing and selection on respective channels. Here, the weight application section 600 does not include information on channels having more-than-one-chip difference from the estimated propagation delay value of a channel having the maximum peak value. The maximum peak value can be acquired using Equation (4).
if (|τ_{\dot{M}}−τₘ|≦1) then τᵥₘ=0
else τᵥₘ=τₘ (4)

In step 707, the ADC-MF 500 increases the variable ‘m’ (m=m+1). In step 708, the ADC-MF 500 determines whether the variable ‘m’ is larger than the number M of transmission antennas. If the variable ‘m’ is not larger than the number M of the transmission antennas, the ADC-MF 500 returns to step 706. However, if the variable ‘m’ is larger than the number M of the transmission antennas, the weight application section 600 acquires selective weighted code timing in step 709. That is, the weight application section 600 derives new estimated propagation delay values in accordance with Equation (5) by applying relative weights to the estimated propagation delay values on the basis of the maximum value using only the estimated propagation delay values for meaningful channels. In other words, as illustrated in FIG. 5, the weight application section 600 compares peak values A_{1,1}, A_{1,2}, A_{1,3}, A_{1,4} of matched filters, and calculates relative weights on the basis of the maximum peak value. The weight application section 600 calculates new estimated propagation delay values by multiplying the previously calculated estimated propagation delay values by the relative weights. It is possible to acquire a code timing using the calculated estimated propagation delay values.

$${τ}_{w} = {\sum }_{m = 1}^{M} \frac{{w}_{m} {τ}_{m}}{{w}_{total}} \\ where {w}_{n} = {‖ \frac{{c}_{1 m}^{T} ( {τ}_{vm} ) {R}_{m} ( χ ) {c}_{1 m} ( {τ}_{vm} )}{{c}_{1 m}^{T} ( {τ}_{vm} ) {c}_{1 m} ( {τ}_{vm} )} ‖}^{2} , and {w}_{total} = {\sum }_{m = 1}^{M} \vert {w}_{m} \vert \qquad ( 5 )$$

In a mobile communication system according to another embodiment of the present invention, a Non Time Division Pilot data Transmission and Selective Weighted Average (NTDPT-SWA) method is used as a code timing acquisition method, and although a transmission side transmits pilot signals using an allocated code in the method used in the prior art, a reception side uses the Selective Weighted Average (SWA) technique described above.

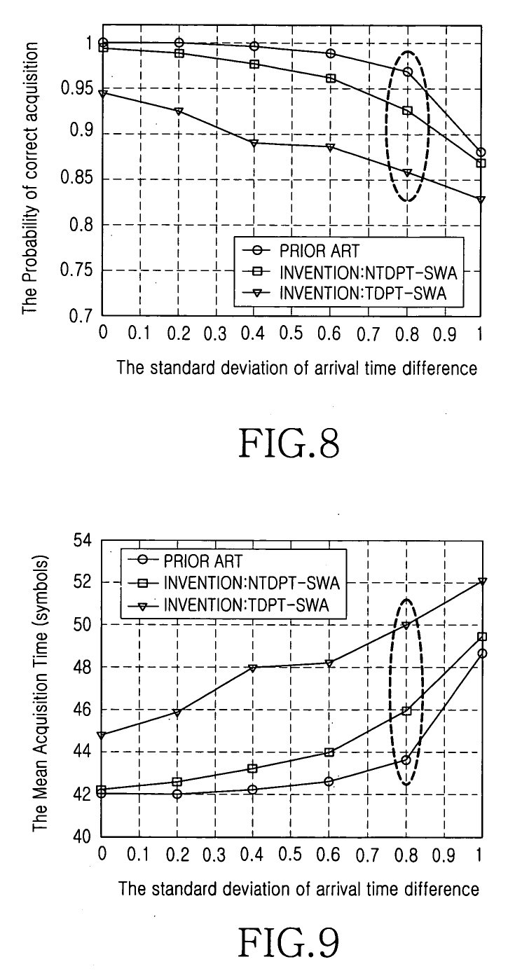

FIG. 8 is a graph illustrating a performance comparison between a code timing acquisition methods in accordance with an embodiment of the present invention and the conventional code timing acquisition method. Referring to the graph of FIG. 8, a horizontal axis represents a standard deviation for an arrival time difference between signals received through multiple paths, and a vertical axis represents a code timing probability. Here, the “code timing” refers to an occasion where a difference between a hypothetical propagation delay value and a propagation delay value estimated in a reception side is less than a half chip. It can be understood from FIG. 8 that the methods proposed in the present invention are superior to the conventional method in code timing performance all over the arrival time difference.

FIG. 9 illustrates a Mean Acquisition Time (MAT) for FIG. 8. The MAT refers to a time required when a reception side repeats a request to a transmission side for additional data upon the reception side's failure in code timing acquisition. Likewise, it can be understood that the methods in accordance with an embodiment of the present invention require less additional data for all of the arrival time difference.

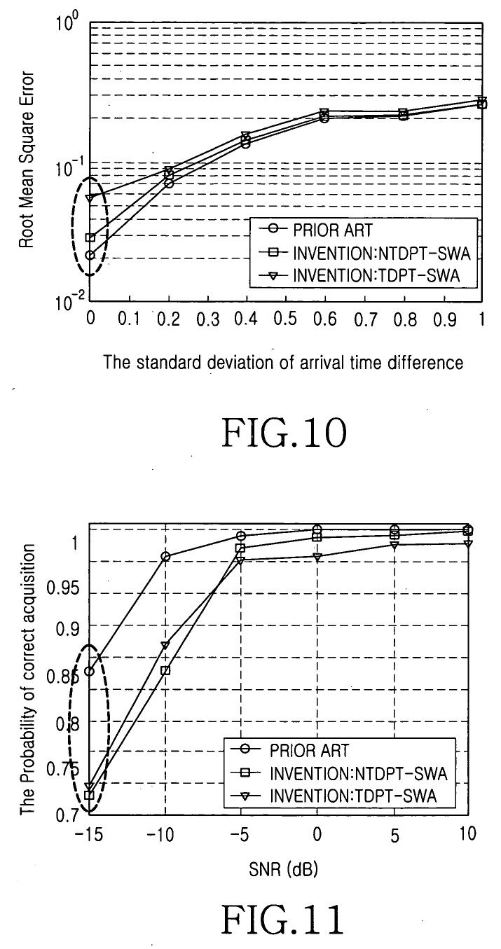

FIG. 10 illustrates a Root Mean Square Error (RMSE) value which is a criterion indicating the correctness of the code timing. It can be understood from FIG. 10 that the methods in accordance with an embodiment of the present invention are lower than the conventional method in terms of RMSE.

FIG. 11 illustrates a function of a signal-to-noise ratio (SNR), and it can be understood that the methods in accordance with an embodiment of the present invention show much higher code timing performance than the conventional method at a low SNR. The improvement in code timing performance contributes to an improvement in Bit Error Rate (BER) performance in terms of detection and to fast code timing acquisition, thereby enabling fast tracing of a variation in the channel.

So far, it has been shown through simulations that the methods provided in the present invention are superior to the conventional method in terms of code timing performance. The reason why the present invention shows higher performance than the conventional method will be analyzed mathematically.

First, the greatest difference between the present invention and the prior art consists in whether a reception side uses the Selective Weighted Average method based on a channel response. The embodiment of the present invention is characterized in that a reception side applies Maximum Ratio Receiver Combining (MRRC) with two antennas in order to increase the signal strength of received signals. It can be noted that in the conventional Accurate Differential Correlated-Matched Filter (ADC-MF), an equation after passing through matched filters is induced to an Equal Average form of each channel.

$$C ( d ) = \frac{\vert {\sum }_{m = 1}^{M} {{η}_{1 m} ( d )}^{T} {R}_{p} ( χ ) {η}_{1 m} ( d ) \vert}{\vert {\sum }_{m = 1}^{M} {{η}_{1 m} ( d )}^{T} {η}_{1 m} ( d ) \vert} \\ where {\sum }_{m = 1}^{M} {{η}_{1 m} ( {d}_{1} )}^{T} {R}_{p} ( χ ) {η}_{1 m} ( {d}_{1} ) = 1 / {M ( {β}_{11} ( χ ) + … + {β}_{M 1} ( χ ) ) [ ( 1 - {δ}_{1} ) g ( 0 ) + {δ}_{1} g ( 1 ) ]}^{2} . \qquad ( 6 )$$

An integer delay value ‘d’ indicating the maximum value and a fractional delay value δ are obtained using Equation (2). By applying the obtained value (τ=d+δ) to Equation (6), a more accurate output value is found. The results are given as Equation (7).

$${\sum }_{m = 1}^{M} {{c}_{1 m} ( τ )}^{T} {R}_{p} ( χ ) {c}_{1 m} ( τ ) = \\ \begin{matrix}1 / {M ( {β}_{11} ( χ ) ) [ ( 1 - ( {δ}_{1} - {\hat{δ}}_{1} ) ) g ( 0 ) + ( {δ}_{1} - {\hat{δ}}_{1} ) g ( 1 ) ]}^{2} + \\ ⋮ \\ 1 / {M ( {β}_{l 1} ( χ ) ) [ ( 1 - ( {δ}_{1} - {\hat{δ}}_{1} ) ) g ( i ) + ( {δ}_{1} - {\hat{δ}}_{1} ) g ( i + 1 ) ]}^{2} + \\ ⋮ \\ 1 / M {( {β}_{M 1} ( χ ) ) [ ( 1 - ( {δ}_{1} - {\hat{δ}}_{1} ) ) g ( 0 ) + ( {δ}_{1} - {\hat{δ}}_{1} ) g ( 1 ) ]}^{2}\end{matrix} \qquad ( 7 )$$

where g(i)=η₁(d)^{T}η₁(d+i), i≠0, lε{1, . . . , M}

That is, when the reception side applies matched filters where an integer delay value for a channel between an l^{th} transmission antenna and a reception antenna is different from an integer delay value of a channel having the maximum value, the results are expressed as Equation (7). As a result, the integer delay value in the prior art can be expressed as Equation (8).

$${\hat{d}}_{ega} = \frac{1}{M} ( {\hat{d}}_{1} + … + {\hat{d}}_{l} + … + {\hat{d}}_{M} ) \qquad ( 8 )$$

An integer delay value estimated based on information on a bad channel affects the entire estimated integer delay values, causing a reduction in performance.

In the embodiment of the present invention, because the reception side can separate channels, the results can be expressed as Equation (9).

$${\hat{d}}_{swa} = \frac{1}{M} ( {ɛ}_{1} {\hat{d}}_{1} + … + {ɛ}_{l} {\hat{d}}_{l} + … + {ɛ}_{M} {\hat{d}}_{M} ) \qquad ( 9 )$$

Here, ε₁, εₗ and ε_{M} are channel selection coefficients. If an unwanted integer delay value is estimated at an l^{th} transmission antenna, ε₁=1, . . . , ε_{M}=1 and εₗ=0 can be allocated to the channel selection coefficients, thereby preventing performance deterioration caused by an unwanted channel. That is, the results can be modified to Equation (10) from which information on an l^{th} channel is deleted.

$${\hat{d}}_{swa} = \frac{1}{M - 1} ( {ɛ}_{1} {\hat{d}}_{1} + … + {ɛ}_{M} {\hat{d}}_{M} ) \qquad ( 10 )$$

Finally, the result of a performance comparison between the embodiments of the present invention and the prior art is given as Equation (11)
|dₜᵣᵤₑ−\hat{d}_{swa}|≦|dₜᵣᵤₑ−\hat{d}_{ega}| (11)

It has been shown from Equation (11) that the embodiment of the present invention is superior to the prior art in terms of propagation delay estimation performance.

As described above, the embodiment of the present invention can improve code timing performance. The improvement in code timing performance contributes to an improvement in BER performance in terms of detection and fast code timing acquisition, thereby enabling fast tracing of a variation in the channel. In addition, if the number of antennas in a transmission side increases, the respective antennas are allocated, thereby preventing an increase in the number of orthogonal codes.

While the invention has been shown and described with reference to a certain embodiment thereof, it should be understood by those skilled in the art that various changes in form and details may be made therein without departing from the spirit and scope of the invention as defined by the appended claims.

1. A reception method for acquiring code timing by receiving pilot signals spread with allocated codes in a receiver using multiple antennas, wherein a transmitter using multiple antennas allocates different codes to pilot signals for transmitting through the respective antennas, the method comprising the steps of:
receiving the spread pilot signals through the respective antennas;
outputting estimated propagation delay values of the pilot signals transmitted from the respective antennas and peak values of matched filters for respective channels; and
calculating new estimated propagation delay value by applying weights determined based on the peak values of matched filters for respective channels to the estimated propagation delay values, and acquiring code timing with the new estimated propagation delay value.

2. The reception method of claim 1, wherein the step of acquiring code timing with the new estimated propagation delay value comprises the steps of:
outputting estimated propagation delay values of respective channels;
searching for peak values of matched filters for the channels using the estimated propagation delay values;
converting the peak values to relative weights, calculating new estimated propagation delay value by applying the relative weights to the estimated propagation delay values.

3. The reception method of claim 1, wherein a maximum value among the peak values is determined by
$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert )$$
where τₘ=dₘ+δₘ.

4. The reception method of claim 1, wherein the new estimated propagation delay value are defined as
$${τ}_{w} = {\sum }_{m = 1}^{M} \frac{{w}_{m} {τ}_{v m}}{{w}_{total}} where$$
$${w}_{n} = {‖ \frac{{c}_{1 m}^{T} ( {τ}_{v m} ) {R}_{m} ( χ ) {c}_{1 m} ( {τ}_{v m} )}{{c}_{1 m}^{T} ( {τ}_{v m} ) {c}_{1 m} ( {τ}_{v m} )} ‖}^{2} , and {w}_{total} = {\sum }_{m = 1}^{M} \vert {w}_{m} \vert$$

5. The reception method of claim 3, wherein the estimated propagation delay values to which the relative weights are to be applied do not include estimated propagation delay values of a channel response, having a more-than-one-chip difference from an estimated propagation delay value.

6. A transmission method for acquiring code timing in a transmitter using multiple antennas, the method comprising the steps of:
allocating different codes to pilot signals for transmitting through the respective antennas at the same time;
spreading the pilot signals with the allocated codes; and
transmitting the spread pilot signals.

7. A reception method for acquiring code timing by receiving pilot signals spread with allocated codes for different times in a receiver using multiple antennas, wherein a transmitter using multiple antennas allocates the same code to pilot signals for transmitting through the respective antennas, the method comprising the steps of:
receiving the spread pilot signals through the respective antennas;
outputting estimated propagation delay values of pilot signals transmitted from the respective antennas and peak values of matched filters for respective channels by separating pilot data output from the respective antennas of the transmitter for different times; and
calculating new estimated propagation delay value by applying weights determined based on the peak values of matched filters for respective channels to the estimated propagation delay values, and acquiring code timing with the new estimated propagation delay value.

8. The reception method of claim 7, wherein the step of acquiring code timing with the estimated propagation delay values comprises the steps of:
outputting the estimated propagation delay values for respective channels;
searching and peak values of matched filters for the respective channels using the estimated propagation delay values; and
converting the peak values to relative weights, and calculating new estimated propagation delay value by applying the relative weights to the estimated propagation delay values.

9. The reception method of claim 7, wherein a maximum value among the peak values is determined by
$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert )$$

10. The reception method of claim 7, wherein the new estimated propagation delay values are defined as
$${τ}_{w} = {\sum }_{m = 1}^{M} \frac{{w}_{m} {τ}_{v m}}{{w}_{total}} where$$
$${w}_{n} = {‖ \frac{{c}_{1 m}^{T} ( {τ}_{v m} ) {R}_{m} ( χ ) {c}_{1 m} ( {τ}_{v m} )}{{c}_{1 m}^{T} ( {τ}_{v m} ) {c}_{1 m} ( {τ}_{v m} )} ‖}^{2} , and {w}_{total} = {\sum }_{m = 1}^{M} \vert {w}_{m} \vert$$

11. The reception method of claim 9, wherein the estimated propagation delay values to which the relative weights are to be applied do not include estimated propagation delay values of a channel response, having a more-than-one-chip difference from an estimated propagation delay value.

12. A transmission method for acquiring code timing in a transmitter using multiple antennas, the method comprising the steps of:
allocating the same code to pilot signals for transmitting through the respective antennas at different times;
spreading the pilot signals with the allocated code; and
transmitting the spread pilot signals.

13. A reception apparatus for acquiring code timing by receiving pilot signals spread with allocated codes, wherein a transmitter using multiple antennas allocates different codes to pilot signals for transmitting through the respective antennas, the apparatus comprising:
an accurate differential correlated-matched filter (ADC-MF) for receiving spread pilot signals transmitted through the respective antennas, and outputting estimated propagation delay values of the pilot signals transmitted through the respective antennas and peak values of matched filters; and
a weight application section for calculating new estimated propagation delay value by applying weights determined based on the peak values of matched filters for respective channels to the estimated propagation delay values, and acquiring code timing with the new estimated propagation delay value.

14. The reception apparatus of claim 13, wherein the weight application section compares the peak values of matched filters for respective channels, converts the peak values into relative weights on the basis of the maximum peak value, calculates new estimated propagation delay value by applying the relative weights to the estimated propagation delay values, and acquires code timing with the new estimated propagation delay value.

15. A reception apparatus for acquiring code timing by receiving pilot signals spread with allocated codes, wherein a transmitter using multiple antennas allocates different codes to pilot signals for transmitting through the respective antennas, the apparatus comprising:
an accurate differential correlated-matched filter (ADC-MF) for receiving spread pilot signals transmitted through the respective antennas, and outputting estimated propagation delay values of the pilot signals transmitted through the respective antennas and peak values of matched filters; and
a weight application section for calculating new estimated propagation delay value by applying weights determined based on the peak values of matched filters for respective channels to the estimated propagation delay values, and acquiring code timing with the new estimated propagation delay value.

16. The reception apparatus of claim 15, wherein the weight application section compares the peak values of matched filters for respective channels, converts the peak values into relative weights on the basis of the maximum peak value, calculates new estimated propagation delay value by applying the relative weights to the estimated propagation delay values, and acquires code timing with the new estimated propagation delay value.

17. The reception apparatus of claim 15, wherein the estimated propagation delay values to which the relative weights are to be applied do not include estimated propagation delay values of a channel response, having a more-than-one-chip difference from an estimated propagation delay value corresponding to a size of a matched filter having the maximum peak value.

18. The reception apparatus of claim 16, wherein the maximum peak value is determined by
$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert )$$
where τₘ=dₘ+δₘ.

19. The reception apparatus of claim 17, wherein the maximum peak value is determined by
$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert )$$
where τₘ=dₘ+δₘ.

20. The reception apparatus of claim 15, wherein the new estimated propagation delay value are defined as
$${τ}_{w} = {\sum }_{m = 1}^{M} \frac{{w}_{m} {τ}_{v m}}{{w}_{total}} where$$
$${w}_{n} = {‖ \frac{{c}_{1 m}^{T} ( {τ}_{v m} ) {R}_{m} ( χ ) {c}_{1 m} ( {τ}_{v m} )}{{c}_{1 m}^{T} ( {τ}_{v m} ) {c}_{1 m} ( {τ}_{v m} )} ‖}^{2} , and {w}_{total} = {\sum }_{m = 1}^{M} \vert {w}_{m} \vert$$

21. A reception apparatus for acquiring code timing by receiving pilot signals spread with allocated codes for different times, wherein a transmitter using multiple antennas allocates the same code to pilot signals for transmitting through the respective antennas, the apparatus comprising:
an accurate differential correlated-matched filter (ADC-MF) for receiving spread pilot signals transmitted through the respective antennas for different times, and outputting estimated propagation delay values of the pilot signals transmitted through the respective antennas and peak values of matched filters by separating pilot data output from the respective antennas for different times; and
a weight application section for calculating new estimated propagation delay value by applying weights determined based on the peak values of matched filters for respective channels to the estimated propagation delay values, and acquiring code timing with the new estimated propagation delay value.

22. The reception apparatus of claim 21, wherein the weight application section compares the peak values of matched filters for respective channels, converts the peak values into relative weights on the basis of the maximum peak value, calculates new estimated propagation delay value by applying the relative weights to the estimated propagation delay values, and acquires code timing with the new estimated propagation delay value.

23. The reception apparatus of claim 21, wherein the estimated propagation delay values to which the relative values are to be applied do not include estimated propagation delay values of a channel response, having a more-than-one-chip difference from an estimated propagation delay value corresponding to a size of a matched filter for a channel having the maximum peak value.

24. The reception apparatus of claim 22, wherein the maximum peak value is determined by
$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert )$$
where τₘ=dₘ+δₘ.

25. The reception apparatus of claim 23, wherein the maximum peak value is determined by
$$\hat{M} = {max}_{m} ( \vert \frac{{c}_{1 m}^{T} ( {τ}_{m} ) {R}_{m} ( χ ) {c}_{1 m} ( {τ}_{m} )}{{c}_{1 m}^{T} ( {τ}_{m} ) {c}_{1 m} ( {τ}_{m} )} \vert )$$
where τₘ=dₘ+δₘ.

26. The reception apparatus of claim 21, wherein the new estimated propagation delay value are defined as
$${τ}_{w} = {\sum }_{m = 1}^{M} \frac{{w}_{m} {τ}_{v m}}{{w}_{total}} where$$
$${w}_{n} = {‖ \frac{{c}_{1 m}^{T} ( {τ}_{v m} ) {R}_{m} ( χ ) {c}_{1 m} ( {τ}_{v m} )}{{c}_{1 m}^{T} ( {τ}_{v m} ) {c}_{1 m} ( {τ}_{v m} )} ‖}^{2} , and {w}_{total} = {\sum }_{m = 1}^{M} \vert {w}_{m} \vert$$
